(19) United States
(12) Patent Application Publication
(10) Pub. No.: US 2023/0151962 A1
(43) Pub. Date: May 18, 2023

(54) PLATE-SHAPED HEAT INSULATOR, COMBUSTION CHAMBER, BOILER AND WATER HEATER

(71) Applicant: IBIDEN CO., LTD., Ogaki-shi (JP)

(72) Inventors: Takahiko OKABE, Ibi-gun (JP); Hiroaki TAKEUCHI, Ibi-gun (JP)

(73) Assignee: IBIDEN CO., LTD., Ogaki-shi (JP)

(21) Appl. No.: 17/988,758

(22) Filed: Nov. 17, 2022

(30) Foreign Application Priority Data
Nov. 18, 2021 (JP) 2021-188067

(51) Int. Cl. F23M 5/02

(52) U.S. Cl. CPC F23M 5/02; F23M 2900/05004

(57) ABSTRACT

The present disclosure provides a plate-shaped heat insulator less susceptible to damage caused by thermal shrinkage. Provided is a plate-shaped heat insulator including an aggregate of multiple heat insulating members containing inorganic fibers, wherein the plate-shaped heat insulator is intended to be disposed in a combustion chamber.

### TECHNICAL FIELD

The present disclosure relates to a plate-shaped heat insulator, a combustion chamber, a boiler, and a water heater.

### BACKGROUND ART

Boilers and water heaters have been used as devices for supplying steam and hot water using fuels such as oil.

In boilers and water heaters, a fuel is combusted in a combustion chamber, and the combustion heat is transferred to water through a water pipe in the combustion chamber for heat exchange, whereby steam and hot water are generated from water.

The combustion chamber is subjected to high temperatures and is thus usually protected with a refractory or a heat insulator to protect peripheral devices from heat damage and to reduce energy loss (for example, see Patent Literature 1 and Patent Literature 2).

Common refractories or heat insulators for use particularly in the combustion chamber subjected to high temperatures from a combustion gas include one obtained by pouring a fluid containing a heat-resistant material onto a surface of an object to be insulated and solidifying the fluid thereon. Such a material is also referred to as a castable material.

### CITATION LIST

### Patent Literature

Patent Literature 1: JP 4946594 B
Patent Literature 2: JP 4640705 B

### SUMMARY OF INVENTION

### Technical Problem

While the castable material can follow a surface of any shape to impart heat insulation, the castable material is formed integrally with a surface of an object to be insulated, so that the castable material is susceptible to damage such as breakage and cracking due to thermal shrinkage.

The present disclosure was made to solve the above issue. An object of the present disclosure is to provide a plate-shaped heat insulator less susceptible to damage caused by thermal shrinkage.

### Solution to Problem

Specifically, the plate-shaped heat insulator of the present disclosure includes an aggregate of multiple heat insulating members containing inorganic fibers, wherein the plate-shaped heat insulator is intended to be disposed in a combustion chamber.

The plate-shaped heat insulator of the present disclosure includes an aggregate of multiple heat insulating members, so that stress due to thermal shrinkage is dispersed instead of being locally concentrated, as compared to an integrated heat insulator. Thus, damage caused by thermal shrinkage is less likely to occur.

Preferably, the plate-shaped heat insulator of the present disclosure is a stack of the multiple heat insulating members stacked in a thickness direction of the plate-shaped heat insulator.

In the case of a single thick plate-shaped heat insulator, stress due to thermal shrinkage is concentrated on a surface of the plate-shaped heat insulator, the surface being adjacent to a combustion chamber. This sometimes increases the risk of causing damage such as cracking in the surface of the plate-shaped heat insulator, the surface being adjacent to the combustion chamber. In contrast, the plate-shaped heat insulator of the present disclosure is a stack of multiple heat insulating members stacked in the thickness direction of the plate-shaped heat insulator and thus can reduce the risk described above.

In the plate-shaped heat insulator of the present disclosure, preferably, at least one of the multiple heat insulating members of the stack includes a recess in a surface facing another heat insulating member.

With such a configuration, an air layer can be formed between two heat insulating members stacked in the thickness direction. This can improve the heat insulation.

Preferably, the plate-shaped heat insulator of the present disclosure is a sheet including the multiple heat insulating members disposed in a plane direction of the plate-shaped heat insulator.

The plate-shaped heat insulator of the present disclosure is a sheet including the multiple heat insulating members disposed in the plane direction of the plate-shaped heat insulator and thus can reduce or prevent breakage or cracking associated with thermal shrinkage in the plane direction.

In the plate-shaped heat insulator of the present disclosure, preferably, two heat insulating members facing each other in the plane direction among the multiple heat insulating members of the sheet are configured such that cross sections thereof parallel to a direction in which the two heat insulating members face each other and parallel to the thickness direction of the plate-shaped heat insulator have shapes that fit each other.

When the two heat insulating members facing each other in the plane direction have cross sectional shapes that fit each other, heat transfer in the thickness direction between the heat insulating members of the sheet can be reduced or prevented. This can improve the heat insulation.

Preferably, the plate-shaped heat insulator of the present disclosure is a multilayer sheet including multiple sheets stacked in the thickness direction of the plate-shaped heat insulator, each sheet being the one defined above, and a position wherethe multiple heat insulating members faces each other in the plane direction varies among the multiple sheets.

With such a configuration, positions where heat transfer in the thickness direction is likely to occur in the sheets do not overlap each other. This improves the heat insulation as a whole.

In the plate-shaped heat insulator of the present disclosure, preferably, the two heat insulating members facing each other in the plane direction are in contact with each other without a gap.

When the two heat insulating members facing each other in the plane direction are in contact with each other without a gap, the heat insulation of the plate-shaped heat insulator can be improved.

In the plate-shaped heat insulator of the present disclosure, preferably, a gap is present between the two heat insulating members facing each other in the plane direction, and the gap is filled with an amorphous material containing an inorganic material.

When the gap between the two heat insulating members facing each other in the plane direction is filled with the amorphous material, a reduction in heat insulation due to the gap between heat insulating members can be reduced or prevented.

In the plate-shaped heat insulator of the present disclosure, preferably, the inorganic fibers include at least one selected from the group consisting of biosoluble fibers, alumina fibers, rock wool, and glass fibers.

When the inorganic fibers include any of these materials, the resulting plate-shaped heat insulator has excellent heat resistance.

In the plate-shaped heat insulator of the present disclosure, preferably, the inorganic fibers have an average fiber length of 0.05 to 3.0 mm.

The inorganic fibers having an average fiber length in the above range result in a stack of plate-shaped molded products with less uneven distribution of the inorganic fibers, thus stabilizing the bulk density and heat insulation properties.

In the plate-shaped heat insulator of the present disclosure, preferably, the heat insulating member has a bulk density of 0.2 to 0.6 g/cm³.

When the heat insulating member has a bulk density in the above range, an increase in weight of the combustion chamber can be reduced or prevented as compared to a refractory material or a heat insulator containing an amorphous material.

In the plate-shaped heat insulator of the present disclosure, preferably, the heat insulating member is a plate-shaped product of papermaking.

The plate-shaped product of papermaking is a plate-shaped molded product obtained by pouring slurry containing an inorganic fiber into a mold and dehydrating by suction (papermaking molding) and drying. Such a plate-shaped product of papermaking is characteristically less deformable with less uneven distribution of the inorganic fibers and is thus suitable as a heat insulating member to be disposed in a combustion chamber.

The combustion chamber of the present disclosure includes a metal container and the plate-shaped heat insulator of the present disclosure on an inner wall surface of the metal container.

Since the combustion chamber of the present disclosure includes the plate-shaped heat insulator of the present disclosure on the inner wall surface of the metal container, the plate-shaped heat insulator is less susceptible to breakage.

In the combustion chamber of the present disclosure, preferably, the plate-shaped heat insulator includes a recess in a surface adjacent to the metal container.

When the plate-shaped heat insulator includes a recess in the surface adjacent to the metal container, the recess can function as an air layer to improve the heat insulation.

In the combustion chamber of the present disclosure, preferably, the plate-shaped heat insulator includes a groove in a surface away from the metal container.

When the plate-shaped heat insulator includes a groove in the surface away from the metal container, such a configuration can reduce or prevent cracking in the plate-shaped heat insulator due to thermal shrinkage, specifically in the surface adjacent to the combustion chamber where the plate-shaped heat insulator is particularly susceptible to heating.

The width and depth of the groove in the surface away from the metal container may vary among parts of the groove.

Variation in the width and depth of the groove depending on parts can alleviate stress resulting from the difference in amount of applied heat among parts of the plate-shaped heat insulator, and cracking can be more effectively reduced or prevented.

In the combustion chamber of the present disclosure, preferably, the plate-shaped heat insulator is on a top surface or a bottom surface of the metal container, and a space between a side surface of the plate-shaped heat insulator and an inner surface of the metal container is filled with an amorphous material containing an inorganic material.

In some cases, it is difficult to completely adjust the dimension of the metal container and the dimension of the plate-shaped heat insulator such that no gap is present therebetween. Even in such cases, a reduction in heat insulation can be reduced or prevented when the space between the side surface of the plate-shaped heat insulator and the inner surface of the metal container is filled with the amorphous material.

The boiler of the present disclosure includes the combustion chamber of the present disclosure.

The boiler of the present disclosure, which includes the combustion chamber of the present disclosure, can reduce or prevent heat damage to peripheral devices. The boiler of the present disclosure can also reduce or prevent a reduction in energy efficiency associated with damage to the plate-shaped heat insulator.

The water heater of the present disclosure includes the combustion chamber of the present disclosure.

The water heater of the present disclosure, which includes the combustion chamber of the present disclosure, can reduce or prevent heat damage to peripheral devices. The water heater of the present disclosure can also reduce or prevent a reduction in energy efficiency associated with damage to the plate-shaped heat insulator.

### BRIEF DESCRIPTION OF DRAWINGS

FIG. 1 is a schematic perspective view of an example of a plate-shaped heat insulator according to a first embodiment of the present disclosure.

FIG. 2 is a cross-sectional view taken along line A-A in FIG. 1.

FIG. 3 is a schematic cross-sectional view of an example of a plate-shaped heat insulator according to a second embodiment of the present disclosure.

FIG. 4 is a schematic cross-sectional view of an example of a plate-shaped heat insulator according to a third embodiment of the present disclosure.

FIG. 5 is a schematic cross-sectional view of an example of a plate-shaped heat insulator according to a fourth embodiment of the present disclosure.

FIG. 6 is a schematic cross-sectional view of an example of a plate-shaped heat insulator according to a fifth embodiment of the present disclosure.

FIG. 7 is a schematic perspective view of an example of a plate-shaped heat insulator according to a sixth embodiment of the present disclosure.

FIG. 8 is a schematic perspective view of an example of a plate-shaped heat insulator according to a seventh embodiment of the present disclosure.

FIG. 9 is a schematic perspective view of an example of a plate-shaped heat insulator according to an eighth embodiment of the present disclosure.

FIG. 10 is a cross-sectional view taken along line B-B in FIG. 9.

FIG. 11 is a schematic cross-sectional view of an example of a plate-shaped heat insulator according to a ninth embodiment of the present disclosure.

FIG. 12 is a schematic cross-sectional view of an example of a plate-shaped heat insulator according to a tenth embodiment of the present disclosure.

FIG. 13 is a schematic cross-sectional view of an example of a combustion chamber according to an eleventh embodiment of the present disclosure.

FIG. 14 is a cross-sectional view taken along line C-C in FIG. 14.

FIG. 15 is a schematic cross-sectional view of an example of a combustion chamber according to a twelfth embodiment of the present disclosure.

FIG. 16 is a schematic cross-sectional view of an example of a combustion chamber according to a thirteenth embodiment of the present disclosure.

FIG. 17 is a schematic cross-sectional view of an example of a combustion chamber according to a fourteenth embodiment of the present disclosure.

FIG. 18 is a schematic cross-sectional view of an example of a boiler according to a fifteenth embodiment of the present disclosure.

FIG. 19 is a schematic cross-sectional view of an example of a water heater according to a sixteenth embodiment of the present disclosure.

### DESCRIPTION OF EMBODIMENTS

### [Plate-Shaped Heat Insulator]

First, the plate-shaped heat insulator of the present disclosure is described.

The plate-shaped heat insulator of the present disclosure includes an aggregate of multiple heat insulating members containing inorganic fibers, wherein the plate-shaped heat insulator is intended to be disposed in a combustion chamber.

Herein, the term “plate-shaped” refers to a shape having two relatively large main surfaces facing each other and a side surface connecting the two main surfaces. The direction in which the two main surfaces extend is also referred to as the plane direction, and the direction in which the two main surfaces are connected is also referred to as the thickness direction. At least one of the two main surfaces facing each other may be curved.

### First Embodiment

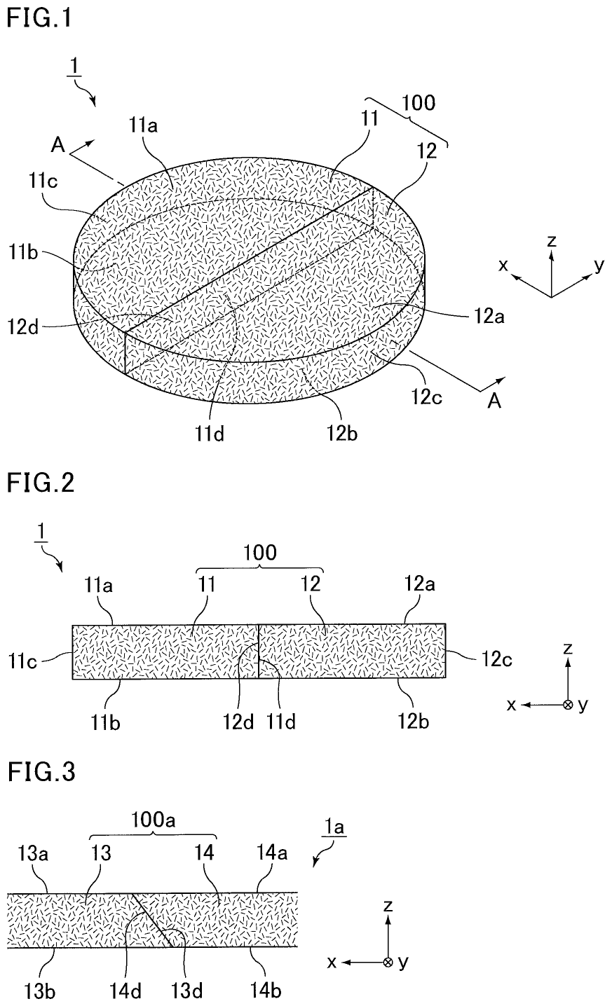

FIG. 1 is a schematic perspective view of an example of a plate-shaped heat insulator according to a first embodiment of the present disclosure. FIG. 2 is a cross-sectional view taken along line A-A in FIG. 1.

A plate-shaped heat insulator 1 shown in FIG. 1 includes an aggregate of multiple heat insulating members 11 and 12 each containing inorganic fibers.

As shown in FIG. 1 and FIG. 2, the plate-shaped heat insulator 1 includes a sheet 100 including the multiple heat insulating members 11 and 12 disposed in the plane direction (xy-plane direction) of the plate-shaped heat insulator.

The plate-shaped heat insulator 1, which includes the sheet 100 including the multiple heat insulating members 11 and 22 disposed in the plane direction (xy-plane direction) of the plate-shaped heat insulator 1, can reduce or prevent breakage or cracking associated with thermal shrinkage in the plane direction.

The heat insulating member 11 has a plate shape including a first main surface 11a and a second main surface 11b having relatively large areas and facing each other, and side surfaces 11c and 11d connecting the first main surface 11a and the second main surface 11b.

The heat insulating member 12 also has a plate shape including a first main surface 12a and a second main surface 12b having relatively large areas and facing each other, and side surfaces 12c and 12d connecting the first main surface 12a and the second main surface 12b.

The plate-shaped heat insulator 1, which includes the sheet 100 including the multiple heat insulating members 11 and 22 disposed in the plane direction (xy-plane direction) of the plate-shaped heat insulator 1, can reduce or prevent breakage or cracking associated with thermal shrinkage in the plane direction.

The first main surface 11a of the heat insulating member 11 and the first main surface 12a of the heat insulating member 12 are also collectively referred to as the first main surface of the sheet 100 or the first main surface of the plate-shaped heat insulator 1. The second main surface lib of the heat insulating member 11 and the second main surface 12b of the heat insulating member 12 are also collectively referred to as the second main surface of the sheet 100 or the second main surface of the plate-shaped heat insulator 1.

The side surface lid of the heat insulating member 11 and the side surface 12d of the heat insulating member 12 are in contact with each other without a gap, but these surfaces may not necessarily be in contact with each other.

In FIG. 1 and FIG. 2, the side surface lid of the heat insulating member 11 and the side surface 12d of the heat insulating member 12 in contact with each other without a gap are shown as the same surface.

When the two heat insulating members 11 and 12 facing each other in the plane direction (xy-plane direction) are in contact with each other without a gap, the heat insulation of the plate-shaped heat insulator 1 can be improved.

When the side surfaces of the heat insulating members are not in contact with each other, the gap between heat insulating members not in contact with each other may be filled with an amorphous material containing an inorganic material.

When the gap between the two heat insulating members facing each other in the plane direction is filled with the amorphous material, a reduction in heat insulation due to the gap between heat insulating members can be reduced or prevented.

The multiple heat insulating members may or may not be bonded to each other via an adhesive or the like.

The multiple heat insulating members may have the same shape or different shapes. When the multiple heat insulating members have the same shape, the production cost can be reduced.

The heat insulating member contains inorganic fibers.

Preferably, the inorganic fibers include at least one selected from the group consisting of biosoluble fibers, alumina fibers, rock wool, and glass fibers.

The biosoluble fibers can be alkaline earth silicate fibers.

When the inorganic fibers include any of these materials, the resulting plate-shaped heat insulator has excellent heat resistance.

The heat insulating member may be a molded product of a solidified amorphous material, a product of papermaking, or a needled product. The heat insulating member may be a plate-shaped molded product, a plate-shaped product of papermaking, or a plate-shaped needled product.

The molded product of a solidified amorphous material is a product obtained by solidifying, drying, and molding an amorphous material containing an inorganic material. The plate-shaped molded product is a product obtained by solidifying, drying, and molding the amorphous material into a plate shape.

The product of papermaking is a molded product obtained by a papermaking method including pouring slurry containing an inorganic fiber into a mold and dehydrating the slurry by suction (papermaking molding) and drying the resulting product. The plate-shaped product of papermaking is a plate-shaped product obtained by the papermaking method.

The needled product is a molded product obtained by needling an aggregate of inorganic fibers. The plate-shaped needled product is a plate-shaped product obtained by needling.

Of these, the heat insulating member is preferably a product of papermaking, more preferably a plate-shaped product of papermaking.

The plate-shaped product of papermaking is characteristically less deformable with less uneven distribution of the inorganic fibers and is thus suitable as a heat insulating member to be disposed in a combustion chamber.

The multiple heat insulating members can be aggregated by a method such as one in which the multiple heat insulating members are disposed with a gap or without a gap on a: surface of an object to be insulated; one in which the multiple heat insulating members are disposed with a gap on a surface of an object to be insulated, and then the gap is filed with an amorphous material containing an inorganic material; or one in which the multiple heat insulating members are bonded to each other with an adhesive or the like.

The average fiber diameter of the inorganic fibers is not limited, but it is preferably 2.0 to 15.0 μm when the heat insulating member is a product of papermaking.

When the heat insulating member is a product of papermaking, the inorganic fibers having an average fiber diameter in the above range result in a dense product of papermaking with less uneven distribution of the density.

The average fiber length of the inorganic fibers is not limited, but it is preferably 0.05 to 3.0 mm when the heat insulating members is a product of papermaking.

When the heat insulating member is a product of papermaking, the inorganic fibers having an average fiber length in the above range result in a plate-shaped multilayer molded product with less uneven distribution of the inorganic fibers, thus stabilizing the bulk density and heat insulation properties.

The bulk density of the heat insulating member is not limited, but it is preferably 0.2 to 0.6 g/cm³ when the heat insulating member is a product of papermaking.

When the heat insulating member has a bulk density in the above range, an increase in weight of the combustion chamber can be reduced or prevented as compared to a refractory material or a heat insulator containing an amorphous material.

In the case of a molded product of an amorphous material containing inorganic fibers, the bulk density can be adjusted by adjusting the amount of water in the amorphous material before drying and solidifying. In the case of a product of papermaking, the bulk density can be adjusted by adjusting compression conditions during dehydration of the slurry and compression conditions during drying. In the case of a needled product, the bulk density can be adjusted by adjusting the needle density during needling and the number of times of needling.

The bulk density of a molded product obtained by drying and solidifying an amorphous material containing inorganic fibers is usually about 0.7 to 1.5 g/cm³. This does not satisfy the preferred bulk density of the heat insulating member described above. The needled product usually has a bulk density of about 0.07 to 0.18 g/cm³. Thus, the heat insulating member is preferably a product of papermaking or a needled product, more preferably a product of papermaking, to adjust the bulk density of the heat insulating member in a suitable range.

Each heat insulating member may include a hole penetrating the heat insulating member in the thickness direction.

Such a hole in the heat insulating member facilitates covering of inner wall surfaces of the combustion chamber including pipes such as a water pipe and a flue gas pipe with the heat insulating member.

The heat insulating member may contain one or more components in addition to the inorganic fibers.

Examples of the one or more components in addition to the inorganic fibers include inorganic particles, inorganic binders, organic binders, and coagulants.

Example of the inorganic particles include silica particles, alumina particles, titania particles, zirconia particles, and natural mineral particles.

Examples of the inorganic binder include silica sol, alumina sol, titania sol, zirconia sol, and fumed silica.

Examples of the organic binder include polyvinyl alcohol, starch, acrylic resin, and polyacrylamide.

Preferably, the weight percentage of inorganic fibers in each heat insulating member is 30 to 97 wt %.

Preferably, each heat insulating member has a volume of 700 to 150000 cm³. When each heat insulating member has a volume in the above range, damage caused by thermal shrinkage is particularly less likely to occur.

The plate-shaped heat insulator of the present disclosure may include a recess or a groove in the surface.

Herein, the recess and the groove are distinguished from each other by the ratio of the length in a width direction (hereinafter, width dimension) to the length in a depth direction (hereinafter, depth dimension) of the recess and the groove in a cross section perpendicular to the direction in which the recess and the groove extend. Specifically, one in which the ratio of the width dimension to the depth dimension is 5 or more is a recess, and one in which the above ratio is less than 5 is a groove.

The groove may partially vary in width and depth.

Variation in the width and depth of the groove depending on parts can alleviate stress resulting from the difference in amount of applied heat among parts of the plate-shaped heat insulator, and cracking can be more effectively reduced or prevented.

In the plate-shaped heat insulator of the present disclosure, preferably, two heat insulating members facing each other in the plane direction among the multiple heat insulating members of the sheet are configured such that cross sections thereof parallel to the direction in which the two heat insulating members face each other and parallel to the thickness direction of the plate-shaped heat insulator have shapes that fit each other.

When the two heat insulating members facing each other in the plane direction have cross sectional shapes that fit each other, heat transfer in the thickness direction between the heat insulating members of the sheet can be reduced or prevented. This can improve the heat insulation.

Herein, the expression “shapes that fit each other” refers to the shapes that allow the two heat insulating members facing each other to be combined together with hardly any gap therebetween when brought into contact with each other. However, when each heat insulating member has a side surface that connects at the shortest distance between one main surface and the other main surface of the heat insulating member, such a side surface does not fall in the above expression. For example, although no gap is present between the heat insulating member 11 and the heat insulating member 12 shown in FIG. 2, these heat insulating members do not have shapes that fit each other.

An example of a case where the two heat insulating members facing each other in the plane direction have cross-sectional shapes that fit each other is described below as second to fifth embodiments.

### Second Embodiment

FIG. 3 is.a schematic cross-sectional view of an example of a plate-shaped heat insulator according to a second embodiment of the present disclosure.

A plate-shaped heat insulator la shown in FIG. 3 includes a sheet 100a including multiple heat insulating members 13 and 14 disposed in a plane direction (xy-plane direction).

A side surface 13d, which faces the heat insulating member 14, of the heat insulating member 13 and a side surface 14d, which faces the heat insulating member 13, of the heat insulating member 14 each have a shape tilted relative to a thickness direction (z-direction) of the plate-shaped heat insulator. Thus, when seen in the cross section, the two heat insulating members 13 and 14 of the sheet 100a have cross-sectional shapes that fit each other.

When the heat insulating members 13 and 14 are configured such that their side surfaces facing each other are tilted when viewed in the cross section, heat transfer in the thickness direction between the heat insulating members of the sheet can be reduced or prevented. This can improve the heat insulation.

When the heat insulating members are configured such that their side surfaces facing each other are tilted, preferably, their side surfaces facing each other each form an angle of 30° to 80° with the first and the second main surfaces of the respective heat insulating members.

### Third Embodiment

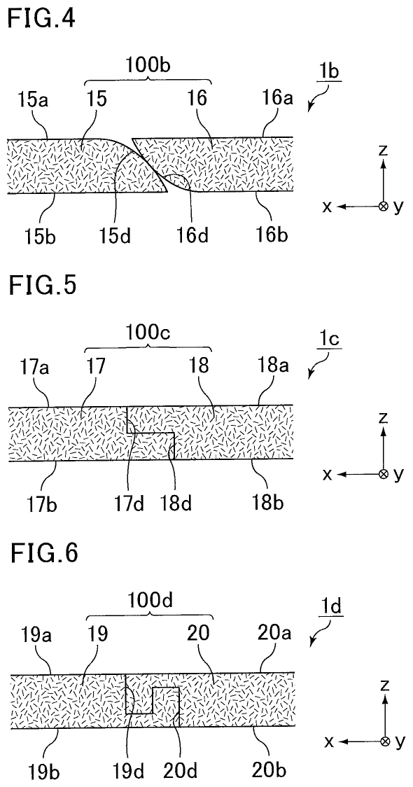

FIG. 4 is a schematic cross-sectional view of an example of a plate-shaped heat insulator according to a third embodiment of the present disclosure.

A plate-shaped heat insulator lb shown in FIG. 4 includes a sheet 100b including multiple heat insulating members 15 and 16 disposed in a plane direction (xy-plane direction).

A side surface 15d, which faces the heat insulating member 16, of the heat insulating member 15 and a side surface 16d, which faces the heat insulating member 15, of the heat insulating member 16 each have a tilted shape that is changed by rounding the obtuse angle thereof. Thus, when seen in the cross section, the two heat insulating members 15 and 16 of the sheet 100b have cross-sectional shapes that fit each other.

The shape obtained by changing the tilted shape is not limited to the above-described shape. For example, the tilted shape may be changed by rounding the acute angle thereof, or the tilted shape may be changed by rounding both the obtuse and acute angles thereof.

### Fourth Embodiment

FIG. 5 is a schematic cross-sectional view of an example of a plate-shaped heat insulator according to a fourth embodiment of the present disclosure.

A plate-shaped heat insulator 1c shown in FIG. 5 includes a sheet 100c including multiple heat insulating members 17 and 18 disposed in a plane direction (xy-plane direction).

A side surface 17d, which is facing the heat insulating member 18, of the heat insulating member 17 and a side surface 18d, which is facing the heat insulating member 17, of the heat insulating member 18 each have an L-shape. Thus, when seen in the cross section, the two heat insulating members of the sheet 100c have cross-sectional shapes that fit each other.

### Fifth Embodiment

FIG. 6 is a schematic cross-sectional view of an example of a plate-shaped heat insulator according to a fifth, embodiment of the present disclosure.

A plate-shaped heat insulator ld shown in FIG. 6 includes a sheet 100d including multiple heat insulating members 19 and 20 disposed in a plane direction (xy-plane direction).

A side surface 19d, which is facing the heat insulating member 20, of the heat insulating member 19 and a side surface 20d, which is facing the heat insulating member 19, of the heat insulating member 20 each have a hook shape. Thus, when seen in the cross section, the two heat insulating members of the sheet 100d have cross-sectional shapes that fit each other.

In each of the first to fifth embodiments above, an example was described in which the plate-shaped heat insulator of the present disclosure includes a sheet including two heat insulating members disposed in the plane direction of the plate-shaped heat insulator.

In the plate-shaped heat insulator of the present disclosure, the sheet may include three or more heat insulating members.

Examples of a case where the sheet includes three heat insulating members are described below as a sixth embodiment and a seventh embodiment.

### Sixth Embodiment

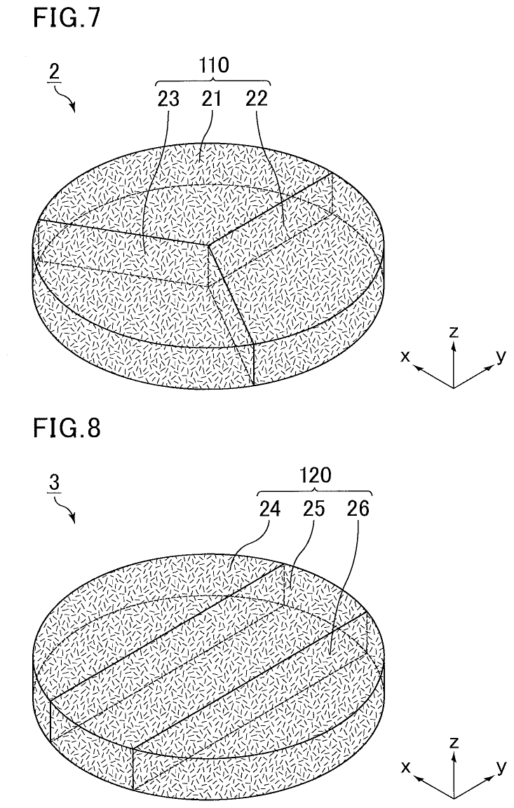

FIG. 7 is a schematic perspective view of an example of a plate-shaped heat insulator according to a sixth embodiment of the present disclosure.

As shown in FIG. 7, a plate-shaped heat insulator 2 includes ;a sheet 110 including multiple heat insulating members 21, 22, and 23 disposed in a plane direction (xy-plane direction).

The heat insulating members 21, 22, and 23 of the sheet 110 each have a fan shape in a planer view, which is obtained by dividing the circle into three equal parts with central angles of 120°. These parts have the same shape.

### Seventh Embodiment

FIG. 8 is a schematic perspective view of an example of a plate-shaped heat insulator according to a seventh embodiment of the present disclosure.

As shown in FIG. 8, a plate-shaped heat insulator 3 includes a sheet 120 including multiple heat insulating members 24, 25, and 26 disposed in a plane direction (xy-plane direction).

The heat insulating members 24, 25, and 26 of the sheet 120 each have a shape obtained by using a straight line extending in the x-direction through the center of the circle as a reference and trisecting the straight line in the x-direction.

The heat insulating member 24 and the heat insulating members 26 have the same shape. The heat insulating member 25 has a shape different from that of the heat insulating members 24 and 26.

In each of the first to seventh embodiments above, an example was described in which the plate-shaped heat insulator of the present disclosure includes a sheet including multiple heat insulating members disposed in the plane direction of the plate-shaped heat insulator.

The plate-shaped heat insulator of the present disclosure may include a stack of multiple heat insulating members stacked in the thickness direction of the plate-shaped heat insulator.

In the case of a single thick plate-shaped heat insulator, stress due to thermal shrinkage is concentrated on a surface of the plate-shaped heat insulator, the surface being adjacent to a combustion chamber. This sometimes increases the risk of causing damage such as cracking in the surface of the plate-shaped heat insulator, the surface being adjacent to the combustion chamber. In contrast, the plate-shaped heat insulator, which includes a stack of multiple heat insulating members stacked in the thickness direction of the plate-shaped heat insulator, can reduce the risk described above.

Examples of a case where the plate-shaped heat insulator includes a stack are described below as an eighth embodiment and a ninth embodiment.

### Eighth Embodiment

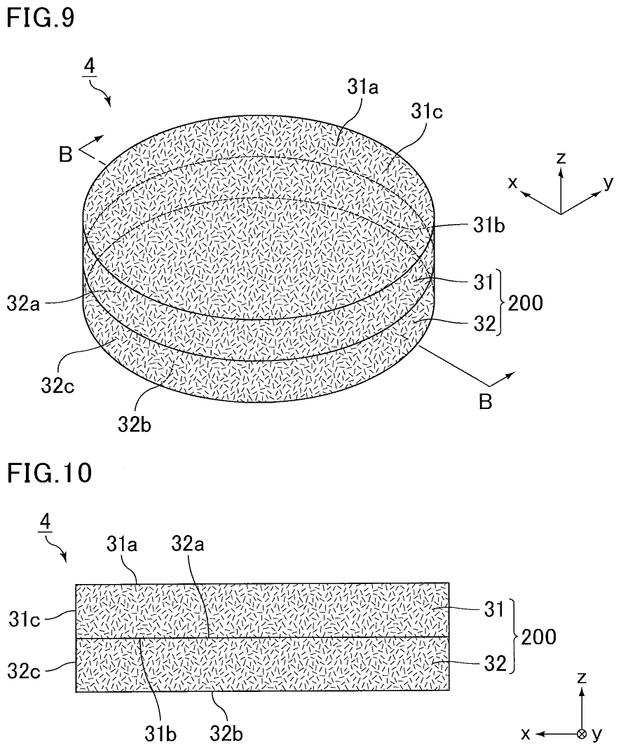

FIG. 9 is a schematic perspective view of an example of a plate-shaped heat insulator according to an eighth embodiment of the present disclosure. FIG. 10 is a cross-sectional view taken along line B-B in FIG. 9.

A plate-shaped heat insulator 4 shown in FIG. 9 includes an aggregate of multiple heat insulating members 31 and 32 containing inorganic fibers.

As shown in FIG. 9 and FIG. 10, the plate-shaped heat insulator 4 includes a stack 200 of the multiple heat insulating members 31 and 32 stacked in a thickness direction (z-direction) of the plate-shaped heat insulator. The heat insulating member 31 has a plate shape including a first main surface 31a, a second main surface 31b, and a side surface 31c connecting the first main surface 31a and the second main surface 31b.

The heat insulating member 32 has a plate shape including a first main surface 32a, a second main surface 32b, and a side surface 32c connecting the first main surface 32a and the second main surface 32b.

As shown in FIG. 10, the second main surface 31b of the heat insulating member 31 and the first main surface 32a of the heat insulating member 32 face each other.

### Ninth Embodiment

In a plate-shaped heat insulator according to a ninth embodiment of the present disclosure, preferably, at least one of the multiple heat insulating members of the stack includes a recess in a surface facing another heat insulating member.

With such a configuration, an air layer can be formed between two heat insulating members stacked in the thickness direction. This can improve the heat insulation.

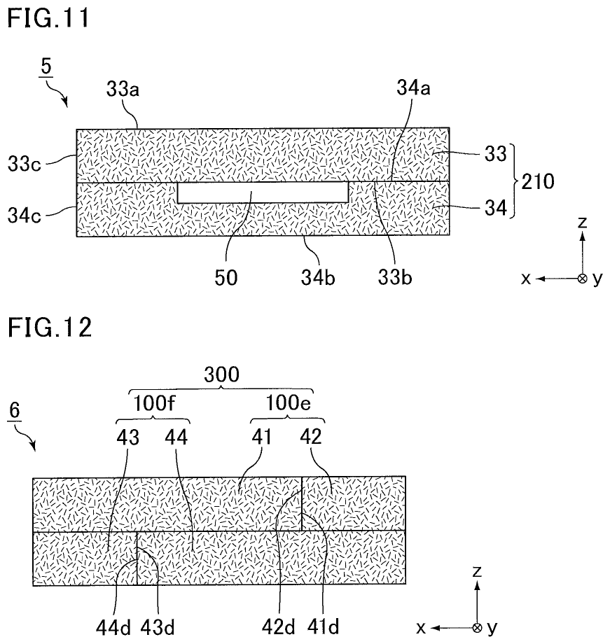

FIG. 11 is a schematic cross-sectional view of an example of a plate-shaped heat insulator according to a ninth embodiment of the present disclosure.

A plate-shaped heat insulator 5 shown in FIG. 11 includes an aggregate of multiple heat insulating members 33 and 34 containing inorganic fibers.

As shown in FIG. 11, the plate-shaped heat insulator 5 includes a stack 210 of the multiple heat insulating members 33 and 34 stacked in a thickness direction (z-direction) of the plate-shaped heat insulator. A second main surface 33b of the heat insulating member 33 and a first main surface 34a of the heat insulating member 34 face each other. Further, the heat insulating member 34 includes a recess 50 in the first main surface 34a.

As shown in FIG. 11, when one of the multiple heat insulating members includes a recess in a main surface (here, the first main surface 34a of the heat insulating member 34) facing the other heat insulating member, an air layer can be formed between the two heat insulating members stacked in the thickness direction. This can improve the heat insulation.

The plate-shaped heat insulator of the present disclosure may be one including multiple heat insulating members in the thickness direction of the plate-shaped heat insulator and including multiple heat insulating members also in the plane direction of the plate-shaped heat insulator. An example of such a case is described below as a tenth embodiment.

### Tenth Embodiment

Preferably, a plate-shaped heat insulator according to a tenth embodiment of the present disclosure is a multilayer sheet including multiple sheets stacked in the thickness direction of the plate-shaped heat insulator. Further, preferably, a position where the multiple heat insulating members face each other in the plane direction varies among the multiple sheets.

FIG. 12 is a schematic cross-sectional view of an example of a plate-shaped heat insulator according to a tenth embodiment of the present disclosure.

A plate-shaped heat insulator 6 shown in FIG. 12 includes a multilayer sheet 300 including multiple sheets 100e and 100f stacked in the thickness direction of the plate-shaped heat insulator.

The sheet 100e includes multiple heat insulating members 41 and 42 disposed in a plane direction (xy-plane direction) of the plate-shaped heat insulator.

The sheet 100f includes multiple heat insulating members 43 and 44 disposed in the plane direction (xy-plane direction) of the plate-shaped heat insulator.

In the plane direction, a position where the heat insulating member 41 and the heat insulating member 42 face each other is different from a position where the heat insulating member 43 and the heat insulating member 44 face each other. In other words, when seen in the cross section, the position where the heat insulating members 41 and 42 face each other (a position between a side surface 41d of the heat insulating member 41 and a side surface 42d of the heat insulating member 42) and the position where the heat insulating members 43 and 44 face each other (a position of a side surface 43d of the heat insulating member 43 and a side surface 44d of the heat insulating member 44) do not overlap each other in a thickness direction (z-direction) of the plate-shaped heat insulator 6.

With such a configuration, positions where heat transfer in the thickness direction is likely to occur in the sheets do not overlap each other. This improves the heat insulation as a whole.

The plate-shaped heat insulator of the present disclosure has been described so far.

Hereinafter, a combustion chamber of the present disclosure including any of the plate-shaped heat insulators of the present disclosure is described.

### [Combustion Chamber]

The combustion chamber of the present disclosure includes a metal container and the plate-shaped heat insulator of the present disclosure on an inner wall surface of the metal container.

Since the combustion chamber of the present disclosure includes the plate-shaped heat insulator of the present disclosure on the inner wall surface of the metal container, the plate-shaped heat insulator is less susceptible to breakage.

### Eleventh Embodiment

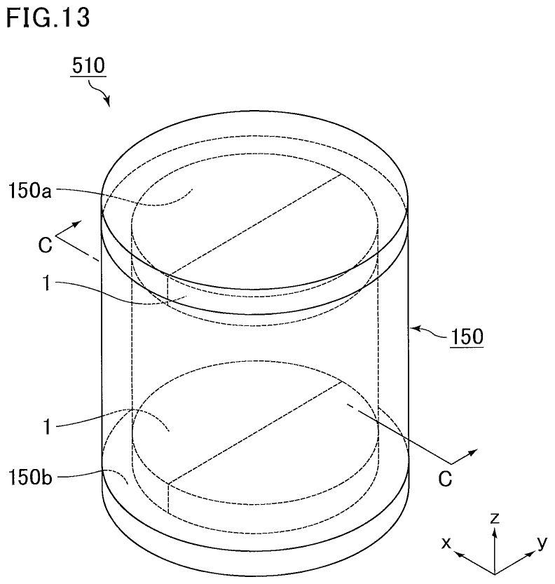

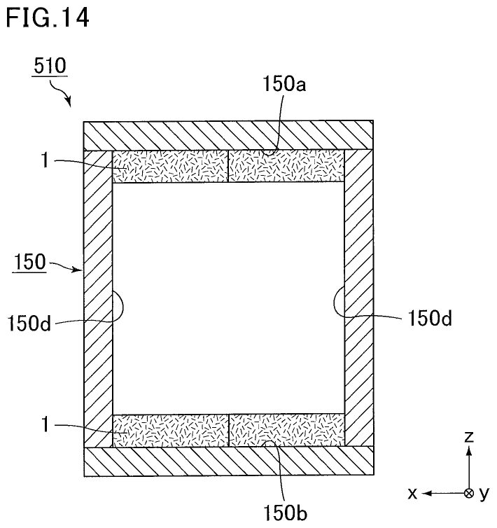

FIG. 13 is a schematic cross-sectional view of an example of a combustion chamber according to an eleventh embodiment of the present disclosure. FIG. 14 is a cross-sectional view taken along line C-C in FIG. 14.

As shown in FIG. 13 and FIG. 14, a combustion chamber 510 includes a metal container 150 and two plate-shaped heat insulators 1 on inner wall surfaces of the metal container. Each plate-shaped heat insulator 1 is the plate-shaped heat insulator of the present disclosure.

An inner space of the metal container 150 is defined by a top surface 150a, a bottom surface 150b, and an inner surface 150d of the metal container 150. The top surface 150a, the bottom surface 150b, and the inner surface 150d of the metal container 150 are inner wall surfaces of the metal container 150 when the metal container 150 is seen from inside.

One of the two plate-shaped heat insulators 1 is disposed to cover the top surface 150a of the metal container from the inside, and the other is disposed to cover the bottom surface 150b of the metal container from the inside.

One of the main surfaces of each plate-shaped heat insulator 1 is the first main surface adjacent to the metal container 150 (adjacent to the top surface 150a or the bottom surface 150b of the metal container 150), and the, other main surface is the second main surface away from the metal container 150 (away from the top surface 150a and the bottom surface 150b of the metal container 150).

The inner diameter dimensions of the top surface 150a and the, bottom surface 150b of the metal container match the outer dimension of the plate-shaped heat insulator 1. In a plane direction (xy-plane direction) of the plate-shaped heat insulator 1, no gap is present between the plate-shaped heat insulator 1 and the inner surface 150d of the metal container 150.

In the combustion chamber of the present disclosure, a recess or a groove may be provided in a surface of the plate-shaped heat insulator, or a gap between the plate-shaped heat insulator and the metal container may be filled with an amorphous material containing an inorganic material. Examples of such cases are described below as twelfth to fourteenth embodiments.

### Twelfth Embodiment

In the combustion chamber of the present disclosure, preferably, the plate-shaped heat insulator includes a recess in a surface adjacent to the metal container.

When the plate-shaped heat insulator includes a recess in the surface adjacent to the metal container, the recess can function as an air layer to improve the heat insulation.

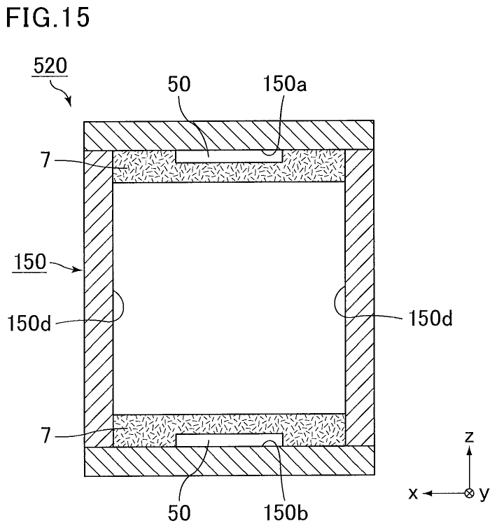

FIG. 15 is a schematic cross-sectional view of an example of a combustion chamber according to a twelfth embodiment of the present disclosure.

As shown in FIG. 15, a combustion chamber 520 includes the metal container 150 and two plate-shaped heat insulators 7 on the top surface 150a and the bottom surface 150b of the metal container 150.

Each plate-shaped heat insulator 7 includes the recess 50 in a surface adjacent to the metal container 150.

When the plate-shaped heat insulator 7 includes the recess 50 in the surface adjacent to the metal container . 150, the recess 50 can function as an air layer to improve the heat insulation of the plate-shaped heat insulator 7.

### Thirteenth Embodiment

In the combustion chamber of the present disclosure, preferably, the plate-shaped heat insulator includes a groove in a surface away from the metal container.

When the plate-shaped heat insulator includes a groove in the surface away from the metal container, such a configuration can reduce or prevent cracking in the plate-shaped heat insulator due to thermal shrinkage, specifically in the surface adjacent to the combustion chamber where the plate-shaped heat insulator is particularly susceptible to heating.

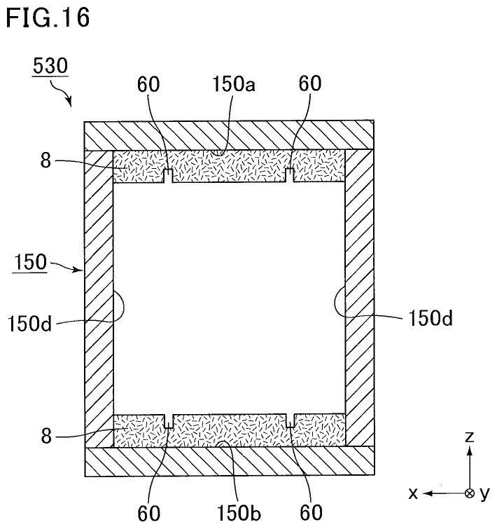

FIG. 16 is a schematic cross-sectional view of an example of a combustion chamber according to a thirteenth embodiment of the present disclosure.

As shown in FIG. 16, a combustion chamber 530 includes the metal container 150 and two plate-shaped heat insulators 8 on the top surface 150a and the bottom surface 150b of the metal container 150.

Each plate-shaped heat insulator 8 includes a groove 60 in a surface away from the metal container 150.

When the plate-shaped heat insulator 8 includes the groove 60 in the surface away from the metal container 150, such a configuration can reduce or prevent cracking in the plate-shaped heat insulator 8 due to thermal shrinkage, specifically in the surface adjacent to the combustion chamber where the plate-shaped heat insulator 8 is particularly susceptible to heating.

### Fourteenth Embodiment

In the combustion chamber of the present disclosure, preferably, the plate-shaped heat insulator is on atop surface or a bottom surface of the metal container, and a space between a side surface of the plate-shaped heat insulator and an inner surface of the metal container is filled with an amorphous material containing an inorganic material.

In some cases, it is difficult to completely adjust the dimension of the metal container and the dimension of the plate-shaped heat insulator such that no gap is present therebetween. Even in such cases, a reduction in heat insulation can be reduced or prevented when the space between the side surface of the plate-shaped heat insulator and the inner surface of the metal container is filled with the amorphous material.

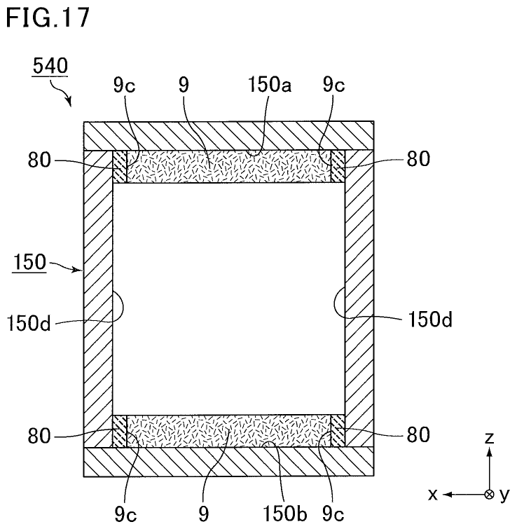

FIG. 17 is a schematic cross-sectional view of an example of a combustion chamber according to a fourteenth embodiment of the present disclosure.

As shown in FIG. 17, a combustion chamber 540 includes the metal container 150 and two plate-shaped heat insulators 9 on the top surface 150a and the bottom surface 150b of the metal container 150.

The plan view dimension (outer diameter dimension) of each plate-shaped heat insulator 9 is smaller than the inner diameter dimension of the inner surface 150d of the metal container 150. Thus, a gap is present between a side surface 9c of the plate-shaped heat insulator 9 and the inner surface 150d of the metal container. The gap is filled with an amorphous material 80 containing an inorganic material. When the gap between the side surface 9c of the plate-shaped heat insulator 9 and the inner surface 150d of the metal container 150 is filled with the amorphous material 80, a reduction in heat insulation can be reduced or prevented.

The combustion chamber of the present disclosure can be used in a device including a combustion chamber. Examples of the device including a combustion chamber include boilers and water heaters.

### [Boiler]

The boiler of the present disclosure includes the combustion chamber of the present disclosure.

The boiler of the present disclosure, which includes the combustion chamber of the present disclosure, can reduce or prevent heat damage to peripheral devices. The boiler of the present disclosure can also reduce or prevent a reduction in energy efficiency associated with damage to the plate-shaped heat insulator.

An example of the boiler of the present disclosure is described below as a fifteenth embodiment.

### Fifteenth Embodiment

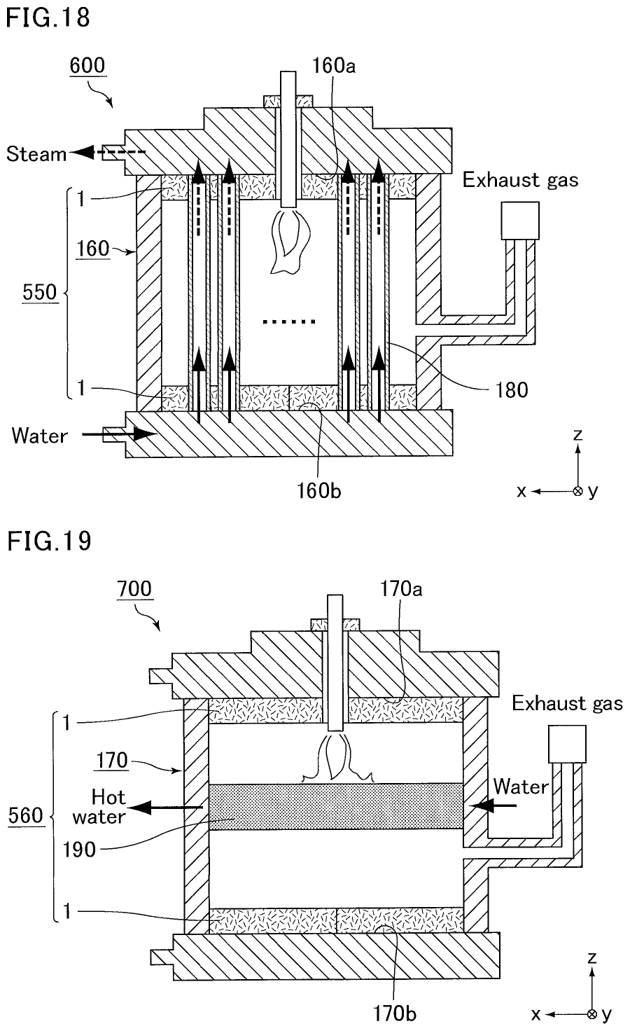

FIG. 18 is a schematic cross-sectional view of an example of a boiler according to a fifteenth embodiment of the present disclosure.

A boiler 600 includes a combustion chamber 550 and water pipes 180 in the combustion chamber 550.

The combustion chamber 550 is a combustion chamber of the present disclosure including a metal container 160 and the plate-shaped heat insulators 1 of the present disclosure on a top surface 160a and a bottom surface 160b of the metal container 160.

Water is supplied into the water pipes 180 from a lower portion of the combustion chamber 550. Water flowing through the water pipes 180 is heated into steam in the combustion chamber 550, and the steam is exhausted from an upper portion of the combustion chamber 550.

The exhausted steam after water separation of the liquid or overheating as needed is used for applications such as power generation, heating, washing, cooking, drying, disinfection, and sterilization.

### [Water Heater]

The water heater of the present disclosure includes the combustion chamber of the present disclosure.

The water heater of the present disclosure, which includes the combustion chamber of the present disclosure, can reduce or prevent heat damage to peripheral devices. The water heater of the present disclosure can also reduce or prevent a reduction in energy efficiency associated with damage to the plate-shaped heat insulator.

An example of the water heater of the present disclosure is described below as a sixteenth embodiment.

### Sixteenth Embodiment

FIG. 19 is a schematic cross-sectional view of an example of a water heater according to a sixteenth embodiment of the present disclosure.

A water heater 700 includes a combustion chamber 560 and a heat exchanger 190 in the combustion chamber 560.

The combustion chamber 560 is a combustion chamber of the present disclosure including a metal container 170 and the plate-shaped heat insulators 1 of the present disclosure on a top surface 170a and a bottom surface 170b of the metal container 170.

Water flows in the heat exchanger 190. The water in the heat exchanger 190 is heated into hot water in the combustion chamber 560, and the hot water is supplied to the outside of the water heater 700.

The temperature of hot water to be supplied can be suitably adjusted by adjusting the amount of fuel to be combusted in the combustion chamber and the amount of water flowing through the heat exchanger per unit time.

### REFERENCE SIGNS LIST

1, 1a, 1b, 1c, 1d, 2, 3, 4, 5, 6, 7, 8, 9 plate-shaped heat insulator
9c side surface of plate-shaped heat insulator 11, 12, 13, 14, 15, 16, 17, 18, 19, 20, 21, 22, 23, 24, 25, 26, 31, 32, 33, 34, 41, 42, 43, 44 heat insulating member 11a, 12a, 13a, 14a, 15a, 16a, 17a, 18a, 19a, 20a, 31a, 32a, 33a, 34a first main surface of heat insulating member 11b, 12b, 13b, 14b, 15b, 16b, 17b, 18b, 19b, 20b, 31b, 32b, 33b, 34b second main surface of heat insulating member 11c, 12c, 24c, 25c, 26c, 31c, 32c, 33c, 34c side surface (outside) of heat insulating member
11d, 12d, 13d, 14d, 15d, 16d, 17d, 18d, 19d, 20d, 41d, 42d, 43d, 44d side surface (inside) of heat insulating member
50 recess
60 groove
80 amorphous material containing inorganic material
100, 100a, 100b, 100c, 100d, 100e, 100f, 110, 120 sheet
150, 160, 170 metal container
150a, 160a, 170a top surface of metal container
150b, 160b, 170b bottom surface of metal container
150d inner surface of metal container
180 water pipe
190 heat exchanger
200 stack
300 multilayer sheet
510, 520, 530, 540, 550, 560 combustion chamber
600 boiler
700 water heater

1. A plate-shaped heat insulator, comprising
an aggregate of multiple heat insulating members containing inorganic fibers,
wherein the plate-shaped heat insulator is intended to be disposed in a combustion chamber.

2. The plate-shaped heat insulator according to claim 1,
wherein the aggregate is a stack of the multiple heat insulating members stacked in a thickness direction of the plate-shaped heat insulator.

3. The plate-shaped heat insulator according to claim 2,
wherein at least one of the multiple heat insulating members of the stack includes a recess in a surface facing another heat insulating member.

4. The plate-shaped heat insulator according to claim 1,
wherein the aggregate is a sheet including the multiple heat insulating members disposed in a plane direction of the plate-shaped heat insulator.

5. The plate-shaped heat insulator according to claim 4,
wherein two heat insulating members facing each other in the plane direction among the multiple heat insulating members of the sheet are configured such that cross sections thereof parallel to a direction in which the two heat insulating members face each other and parallel to the thickness direction of the plate-shaped heat insulator have shapes that fit each other.

6. The plate-shaped heat insulator according to claim 4,
wherein the plate-shaped heat insulator is a multilayer sheet including multiple sheets stacked in the thickness direction of the plate-shaped heat insulator, each sheet being the one defined above, and
a position where the multiple heat insulating members face each other in the plane direction varies among the multiple sheets.

7. The plate-shaped heat insulator according to claim 4,
wherein the two heat insulating members facing each other in the plane direction are in contact with each other without a gap.

8. The plate-shaped heat insulator according to claim 4,
wherein a gap is present between the two heat insulating members facing each other in the plane direction, and
the gap is filled with an amorphous material containing an inorganic material.

9. The plate-shaped heat insulator according to claim 1,
wherein the inorganic fibers include at least one selected from the group consisting of biosoluble fibers, alumina fibers, rock wool, and glass fibers.

10. The plate-shaped heat insulator according to claim 1,
wherein the inorganic fibers have an average fiber length of 0.05 to 3.0 mm.

11. The plate-shaped heat insulator according to claim 1,
wherein the heat insulating member has a bulk density of 0.2 to 0.6 g/cm³.

12. The plate-shaped heat insulator according to claim 1,
wherein the heat insulating member is a plate-shaped product of papermaking.

13. A combustion chamber comprising:
a metal container; and
the plate-shaped heat insulator according to claim 1 on an inner wall surface of the metal container.

14. The combustion chamber according to claim 13,
wherein the plate-shaped heat insulator includes a recess in a surface adjacent to the metal container.

15. The combustion chamber according to claim 13,
wherein the plate-shaped heat insulator includes a groove in a surface away from the metal container.

16. The combustion chamber according to claim 13,
wherein the plate-shaped heat insulator is on a top surface or a bottom surface of the metal container, and
a space between a side surface of the plate-shaped heat insulator and an inner surface of the metal container is filled with an amorphous material containing an inorganic material.

17. A boiler comprising
the combustion chamber according to claim 13.

18. A water heater comprising
the combustion chamber according to claim 13.
